(19) United States
(12) Patent Application Publication
(10) Pub. No.: US 2019/0256146 A1
(43) Pub. Date: Aug. 22, 2019

(54) THE STRENGTHEN PART FOR CONNECTING POINT ON CHASSIS AND ITS MANUFACTURING

(71) Applicant: AAPICO AMATA COMPANY LIMITED, Chonburi (TH)

(72) Inventor: Mitsuru OBARA, Chonburi (TH)

(73) Assignee: AAPICO AMATA COMPANY LIMITED, Chonburi (TH)

(21) Appl. No.: 16/345,730

(22) PCT Filed: Oct. 31, 2017
(86) PCT No.: PCT/TH17/00078

§ 371 Date: Apr. 29, 2019

(30) Foreign Application Priority Data
Oct. 31, 2016 (TH) 1601006573

(51) Int. Cl. B62D 21/02; B62D 21/15

(52) U.S. Cl. CPC B62D 21/02; B62D 21/15

(57) ABSTRACT

The purpose of this invention is for the better way to connect chassis, to improve safety when car crashed, by change the method of connecting chassis together from articulate two parts together into using high-temperature welding and the strengthen part has been added for help this welding process and improve safety when car crashed In addition, chassis have a better quality, lower price and easier to manufacturing.

### TECHNICAL FIELD

The present invention relates generally to the field of chassis manufacturing.

### BACKGROUND ART

From the past until now chassis have been changed and separated in many formations; depend on the functional of automobiles. For Pick-Up truck and SUV, the most important of the chassis functional is its toughness as for the safety of driving. Thus, chassis will departed into 2-4 sections or higher for the purpose of improve its toughness. Usually it will separated in 3 sections consist front, middle and rear. Each part has been formed by using 2 Steel U Beam welded together on the surface. Chassis has been strengthening for a bit and must have arched at the front for increase the space available for the steering movement of the front wheel. On this day, this procedure just fundamental steps for produce heavy-load vehicle such as Pick-Up truck and SUV.

However, even current chassis are more strengthen than before, there still a weakness from the manufacturing, especially the result from high-temperature welding process that affect the material, the range of effect is the material may transfigure a little bit that could be reform until the material transfigure beyond fatigue level which make the chassis material broken or bended and cannot reform into the ordinary form. If the fracture happens in an important area as the connecting point of chassis, this fatigue in connecting point can harm the cabin.

According to a further feature of the invention the problem is solved by using the technique of high-temperature welding to strengthen the connecting point and improve safety in the event of car crashed. Moreover, among the objects of the invention are more convenient manufacture.

As the result from searching, there has no such an invention which has been granted a patent or anticipated by prior art that strengthen the connecting point of chassis by the same method.

### SUMMARY OF THE INVENTION

The purpose of this invention is for the better way to connect chassis, to improve safety when car crashed. This invention is the result from the study in relationship between the cracked point and the cabin when car crashed. As the report, damages on cabin did not come from the formation or the weakness of chassis material but it is because the effect of high-temperature welding that materials are overload and make the connecting point weaken until it became the weak point of the chassis when car crashed. So, in order to strengthen such a connecting point, the strengthen part and its manufacturing has been invented for help car assembly and improve safety when car crashed In addition, chassis have a better quality, lower price, greater simplicity and more convenient manufacture.

The strengthen part for connecting point are consist of front. Middle and rear hollow rectangular prisms with the connecting point with each other. When we look at cross section view of the prisms, we will see both internal part and external part. The Specification of this chassis connecting point is that there is a strengthen part As a helper when connecting between two parts of chassis. The front strengthen part will connect with the first chassis part and The rear strengthen part will connect with the second chassis part by means of The front strengthen part will connect with the external of the chassis but hidden inside chassis and The rear strengthen part will connect with the internal of the chassis but explode outside chassis.

The purpose and specification of this invention will be more clearly and fully understood from the embodiments illustrated in the attached drawing and from the following description thereof.

### BRIEF DESCRIPTION OF DRAWINGS

The following drawings form part of the present specification and are included to further demonstrate certain aspects of the present invention. The present invention may be better understood by reference to one or more of these drawings in combination with the detailed description of specific embodiments presented herein.

FIG. 1 is the position of chassis frame inside the car.

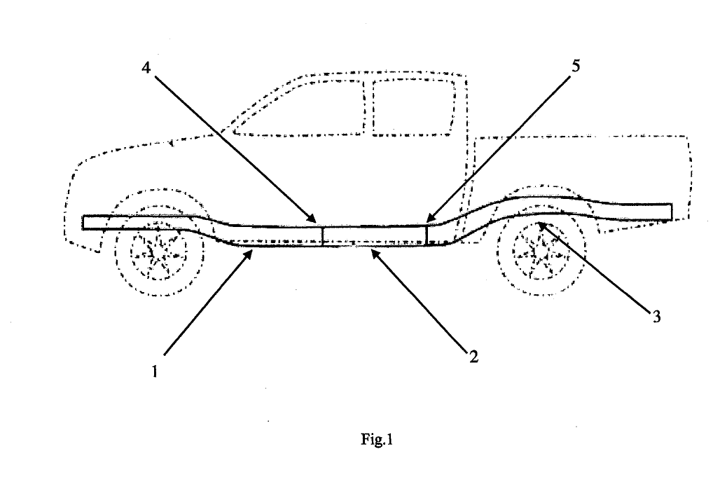

FIG. 2 is a plan view of a chassis frame

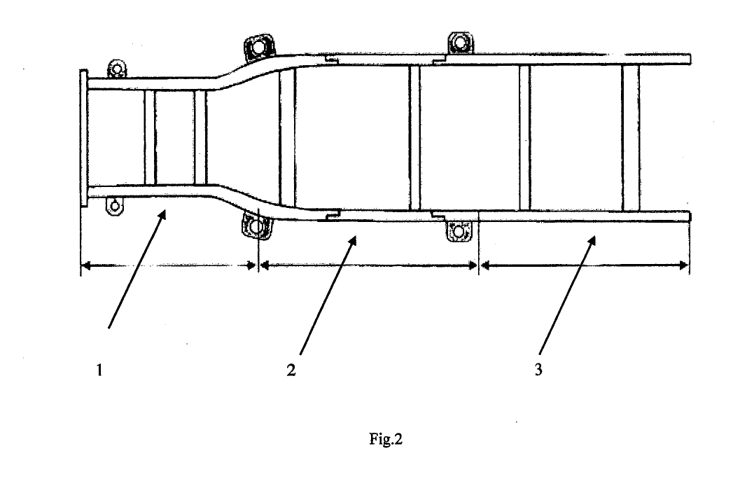

FIG. 3 is a side view of the chassis

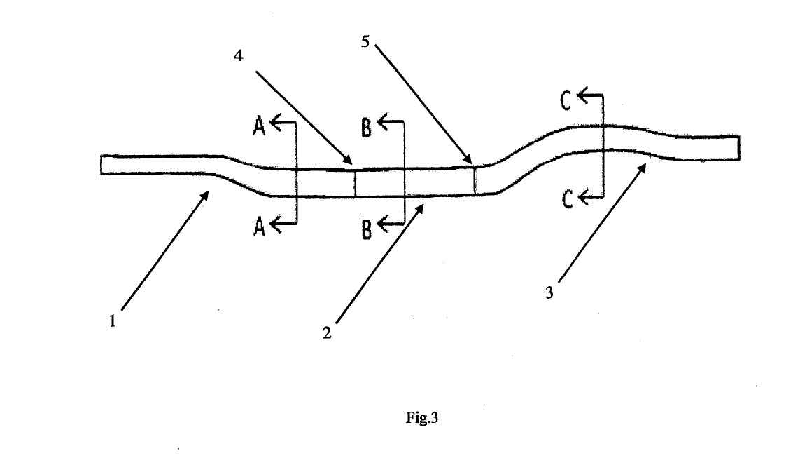

FIG. 4 is a cross-section view from the chassis that has been exploded into three-quarter

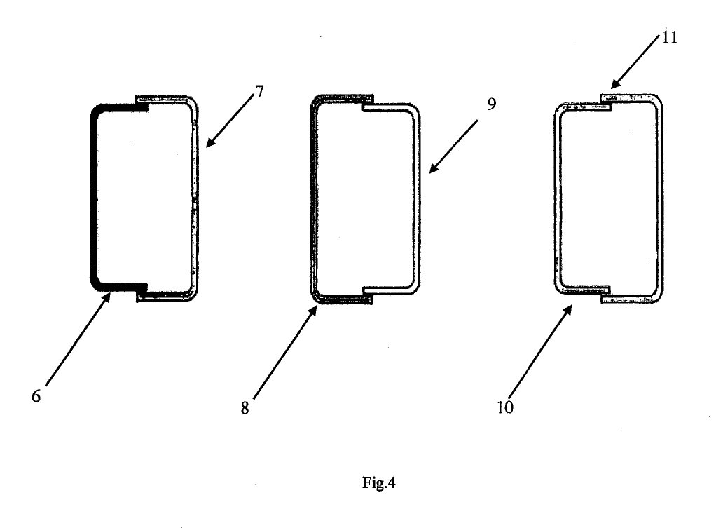

FIG. 5 is a chassis in the case of cars crashed

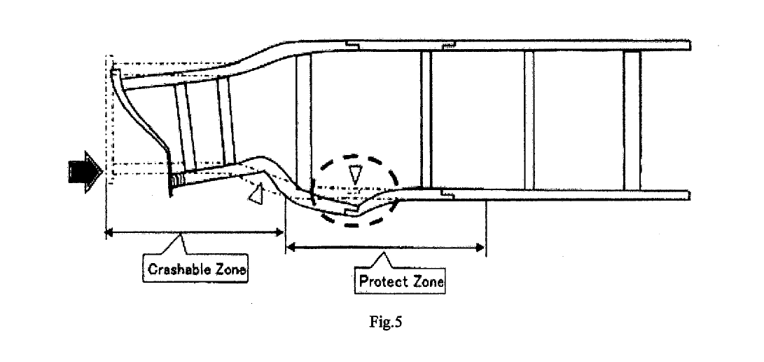

FIG. 6 is the position of strengthen part in chassis

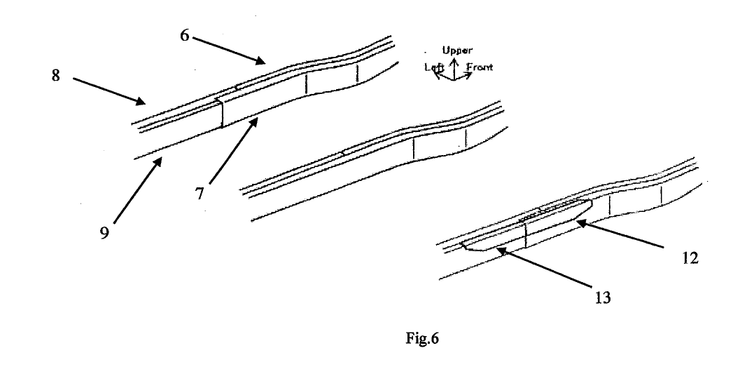

FIG. 7 is the position of strengthen part after all chassis part are connected

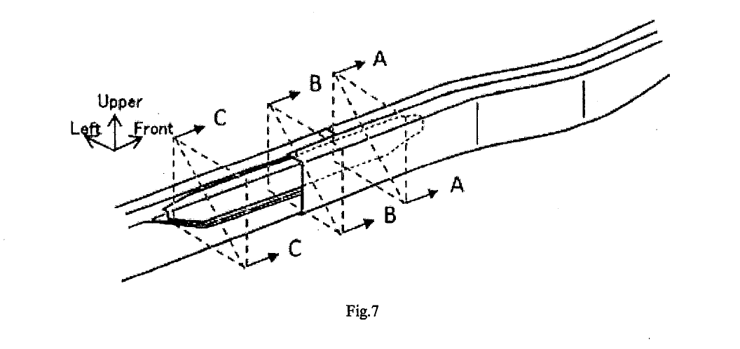

FIG. 8 is a 3 cross-section views of strengthen part after all chassis part are connected

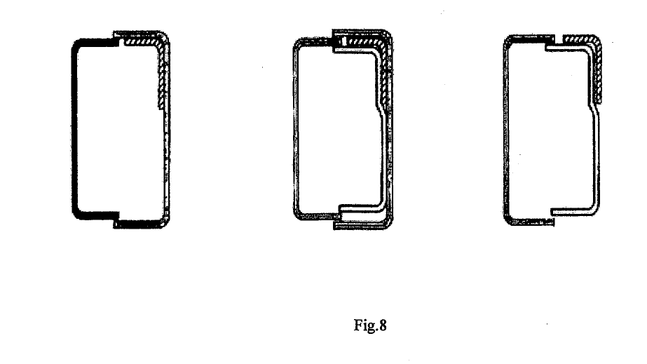

FIG. 9 is an exploded view of the chassis frames

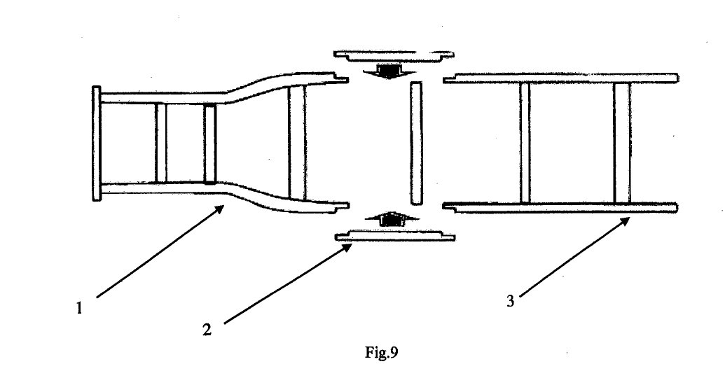

FIG. 10 is the method of connecting the strengthen with chassis

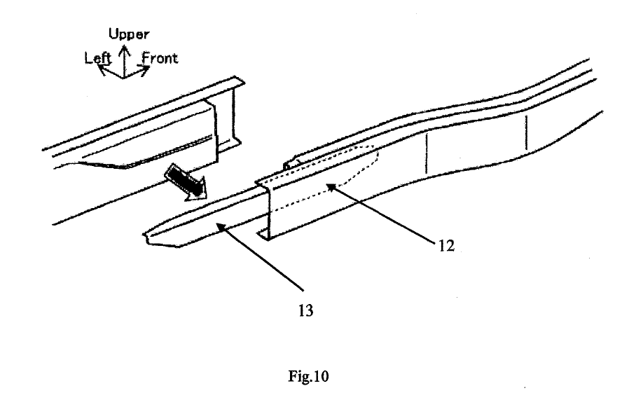

The figures and written description are not intended to limit the scope of the disclosed method for preparing the strengthen part for connecting point on chassis in any manner. Rather, the figures and written description are provided to illustrate the disclosed method for preparing the strengthen part for connecting point on chassis to a person having ordinary skill in the art by reference to particular embodiments of the invention. The invention will now be described with such particularity as to enable any person skilled in the pertinent art to practice the invention without extensive experimentation.

### DETAILED DESCRIPTION OF THE INVENTION

Chassis that has been cross section cut are consist of three parts include the front (1), the middle (2) and the rear (3). For the connecting point between the front and the middle (4), the middle and the rear (5) have the same structure which will describe below

Such a chassis has a frame that origin from outer and inner of cross section cut hollow rectangular prisms welded to each other. The front frame has an inner side (7) bigger than an outer side (6). Thus, an inner side rim (7) covered some part of an outer side rim (6). On the contrary, an outer side of middle frame (8) is bigger than an inner side (9) Then, an outer side rim (8) has covered some part of an inner side rim (9)

The rear end of front Chassis (1) has an inner side (7) longer than an outer side (6). Although there is no specific overall length. In contrast, the front end of middle Chassis (2) has an outer side (8) longer than an inner side (9) for connect with the front at the connecting point (4) the technique are common trait to build modern-day cars.

The rear end of front chassis (1) will connect with the middle Chassis (2) as mentioned above. In this step, the strengthen part will be installed inside the chassis frame by welding with the extended surface from the front chassis (1), the middle chassis (2) and will be done before connect all other connecting point together.

The next step will explain how to install the strengthen part.

First, put the front part (1) or the rear part (3) of chassis in holding machine then put the outer side of middle frame (8) on side direction then welded together. After connected put the strengthen part, then put an inner side of middle frame (9) facing each other and having their side walls overlapping welded to each other to make an inner side of middle frame (9) and the strengthen part merged into the same piece.

Second, As the strengthen part will be an extension to help the front chassis (1) and the middle chassis (2) connected together by welding. On one hand, the connecting point of front Chassis (4) will connect with the front end of the strengthen part (12). On the other hand, the middle chassis (2) will connect with the rear end of the strengthen part (13) and also connected with an outer surface of the inner side of middle frame that can be seen by eyes.

The next step will explain chassis assembly after the strengthen part has been installed.

The front chassis consist of an inner side (7) and an outer side (6). That connected together with the strengthen part by welding and the rear chassis consist of an inner side (11) and an outer side (10). That connected together with the strengthen part by welding. Both parts of chassis will be hold together by holding machine. Then the middle chassis will be penetrated between the rear end of front chassis and the front end of middle Chassis. Finally, all parts will be welded together

The strengthen part that has been attached make it different from known manufacture that use high-temperature weld hollow rectangular prisms together and caused eccentricity such as bended or deformation which hard to control the quality of the object after welding. Furthermore, it hard to spread the work out when many fragmentary need to connected together make the chassis overload. Whereof the strengthen part are installed the stress load on the chassis has lower than before so, the connecting points are strengthen as same as the safety when car crashed.

The Benefit from the Strengthen Part

By welding every connecting point together with the strengthen part make the frame durable to Twisting, so it is not easy to broken or Twisted. Moreover, the front chassis are shock absorber that improves the safety.

On one hand, the result from higher capability, the car cabin is harder to be crashed. Consider the safety of the passenger as the first priority, a car that has the strengthen part installed is significantly safer than a non-installed car.

On the other hand, on production and economic views, the use of strengthen part installed in the chassis helps the car assembly easier and can conserve production resource because there is no additional step after welding.

Even the invention are completely describe with an example in the attached drawing, any adaptation or reformation can be done if not beyond the scope and the purpose of the invention and has done by an intermediate professional in the art related. The scope of the invention are as the description in according to the claims include the nature of the invention that not specific in the claims but has benefit and effect In the same way as describe in the claims.

### BEST MODE FOR CARRYING OUT THE INVENTION

As mentioned in disclose the Detailed Description of the Invention.

1. The strengthen part for connecting point are consist of hollow rectangular prisms separate into the front part (1), the middle part (2) and the rear part (3) have a connecting point between the front and the middle (4), the middle and the rear (5).

2. The hollow rectangular prisms has been cross section cut into internal part and external part. The Specification of this chassis connecting point is that there is a strengthen part as a helper when connecting between two parts of chassis. The front strengthen part will connect with the first chassis part and the rear strengthen part will connect with the second chassis part.

3. The strengthen part for connecting point according to claim 1 having said the front strengthen part (12) connect with the external of the chassis but hidden inside chassis.

4. The strengthen part for connecting point according to claim 1 having said the rear strengthen part (13) connect with the internal of the chassis but explode outside chassis.

5. The strengthen part for connecting point will assemble the front, the middle and the rear by put the front part (1) and the rear part (3) in holding machine that has a specific method in connecting the middle part (2) of chassis on side direction and connected with the strengthen part that pop out from the front part and the rear chassis.

6. The strengthen part for connecting point according to claim 4 having said connecting by welding.
